(19) United States
(12) Patent Application Publication
(10) Pub. No.: US 2008/0311533 A1
(43) Pub. Date: Dec. 18, 2008

(54) Direct bond bracket application instrument

(76) Inventors: David D. Gillanders, Brea, CA (US); Kimberly Kim-Chi Nguyen, Huntington Beach, CA (US)

Correspondence Address: David D. Gillanders, 226 Chevy Chase Drive, Brea, CA, 92821, US

(21) Appl. No.: 12/214,078

(22) Filed: Jun. 17, 2008

Related U.S. Application Data
(60) Provisional application No. 60/934,875, filed on Jun. 18, 2007.

(51) Int. Cl. A61C 3/00

(52) U.S. Cl. 433/8

(57) ABSTRACT

An orthodontic instrument that provides for improved placement of direct bond brackets, particularly in the difficult posterior locations. An ergonomic, lightweight, ambidextrous parallel moving jaw assembly which utilizes a familiar hypodermic syringe style interface, enables a practitioner to efficiently and accurately place and bond brackets. Two different jaw blade widths allow engagement with and angular pre-bonded adjustment of Cuspid and Bicuspid brackets.

### CROSS-REFERENCE TO RELATED APPLICATIONS

This application claims the benefit of provisional patent application Ser. No. 60/934,875, filed Jun. 18, 2007 by the present inventors.

### BACKGROUND

1. Field of Invention

The present application pertains to a direct bond bracket application instrument for use by orthodontists in positioning, placing, and bonding orthodontic brackets for the purpose of correcting malocclusions of the teeth. The brackets are cemented to the teeth in specific positions by the orthodontist and are provided with features to engage various tensioning devices such as metal wires, ligatures and elastic bands.

2. Prior Art

The practice of orthodontics involves repositioning and aligning a patient's teeth for improved occlusion and aesthetic appearance. Orthodontic treatment often involves the use of slotted appliances, known as brackets, which are fixed to the patient's anterior, cuspid, bicuspid, or molar teeth. An archwire is received in the slot of each bracket and serves as a track to guide movement of the teeth to desired orientations. The ends of the archwire are usually received in appliances known as buccal tubes that are secured to the patient's molar teeth.

In general, orthodontic appliances that are adapted to be adhesively bonded to the patient's teeth are placed on the teeth by either one of two methods: a direct bonding method, or an indirect bonding method. In the direct bonding method, the appliance and adhesive are grasped with a pair of tweezers or other hand instrument and placed by the practitioner on the surface of the tooth in an approximate desired location. Next, the appliance is shifted along the surface of the tooth as needed until the practitioner is satisfied with its position. Once the appliance is in its precise, intended location, the appliance is pressed firmly onto the tooth to seat the appliance in the adhesive. Excess adhesive in areas adjacent the base of the appliance is removed, and the adhesive is then allowed to cure and fix the appliance firmly in place. Typical adhesives include light-curable adhesives that begin to harden upon exposure to actinic radiation, and two-component chemical-cure adhesives that begin to harden when the components are mixed together.

In the indirect bonding technique, a transfer tray having a shape that matches the configuration of at least part of a patient's dental arch is fabricated. A set of appliances such as brackets are releasably connected to the tray at certain, predetermined locations. Adhesive is applied to the base of each appliance, and the tray is then placed over the patient's teeth until such time as the adhesive cures. The tray is then detached from the teeth as well as from the brackets, which are bonded to the respective teeth at their predetermined locations.

The direct bonding technique described above is in widespread use and is considered satisfactory by many, but there are shortcomings that are inherent with the technique. For example, access to surfaces of malposed teeth may be difficult. In some instances, and particularly in connection with posterior teeth, the practitioner may have difficulty seeing the precise position of the bracket relative to the tooth surface. The importance of accuracy of bracket placement cannot be overstated in regards to a successful treatment outcome. The problems resulting from improperly positioned brackets could be greatly mitigated with an improved application instrument.

A range of prior art instruments are presently in use. A tweezers design with an X-type crossover configuration is the most common type, as disclosed by Cusato, U.S. Pat. No. 4,035,919, Ridgeway, U.S. Pat. No. 4,487,580 and McGann, U.S. Pat. No. 6,786,719B2. These designs allow for adequate access and field of view for the anterior teeth only. The inherent obstructions of a patient's mouth and cheek make this type of instrument unusable at the posterior teeth locations. A tweezer design also necessarily causes the bracket gripping aspects of the instrument to move angularly as they are opened to accommodate various bracket widths. The resultant non-parallel gripping force can expel some brackets from the instrument with potentially injurious velocity. The expensive brackets may also be lost or, if found, require re-sterilization when this occurs.

A cylindrical telescoping jaw design instrument (Ortho Organizers Catalog 2007, pg. 120, item 200-311) is offered for posterior locations where the tweezer design is not suitable due to the aforementioned interferences of the patient's mouth and cheek. While the parallel jaws constitute an improvement, in practice this type of instrument is awkward and inefficient to use. A spring tensioned collar must be moved axially along the body of the instrument in order to open the jaws, requiring two-handed use. Use of this instrument obscures the practitioner's field of view, requires unnatural hand positioning, and therefore results in a less efficient and accurate placement of the bracket.

### OBJECTS AND ADVANTAGES

Accordingly, one object and advantage of the present invention is to provide an improved instrument for the accurate positioning, placement and bonding of direct bond orthodontic brackets. Through improved ergonomics and a jaw mechanism providing increased field of vision, the improvement will also result in increased efficiencies and reduced fatigue of the practitioner. Additional objects and advantages will become apparent from a consideration of the drawings and ensuing descriptions thereof.

### SUMMARY

The present invention comprises a sliding single-hand-use ambidextrous parallel moving jaw mechanism which will enable a practitioner to easily and accurately place and bond orthodontic brackets, especially at the inherently more difficult posterior teeth locations. The instrument's ambidextrous jaw design, lightweight balanced form, and familiar hypodermic syringe style interface result in an ergonomically superior unit. A flat jaw blade that will engage a slot feature in many common bracket types will provide for fine angular adjustment prior to bond cure. The tool's simple design with a minimum of moving parts and selection of construction materials, make it suitable for sterilization in all types of current systems, including vacuum steam autoclaves.

### BRIEF DESCRIPTION OF THE DRAWINGS

FIG. 1 is a left side plan view of a first embodiment of a Direct Bond Bracket Application Instrument.

FIG. 2 is a top plan view of the first embodiment of the invention.

FIG. 3 is a left side plan view of the first embodiment of the invention in an open position.

FIG. 4 is a partial left side plan view of the first embodiment of the invention grasping one type of orthodontic bracket.

FIG. 5 is a partial left side plan view of the first embodiment of the invention engaged with a second type of orthodontic bracket.

FIG. 6 is a left side exploded plan view of the first embodiment of the invention.

FIG. 7 is a top plan view of a jaw slide of the first embodiment of the invention.

### REFERENCE NUMERALS

1 finger support member

2 slidable member

3 stationary member

4 upper gripping jaw

5 lower gripping jaw

6 typical buccal tube bracket

7 tooth

8 typical cuspid/bicuspid bracket

9 rear screw

10 rear guide bushing

11 spring

12 spring aperture

13 rear guide slot

14 forward guide slot

15 forward guide bushing

16 forward screw

17 lingual surface

18 buccal surface

19 distal surface

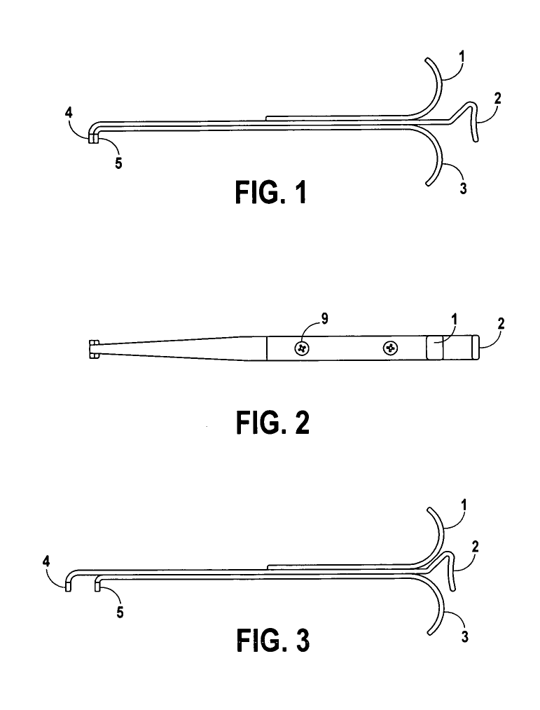

### PREFERRED EMBODIMENT DESCRIPTION—FIGS. 1, 2, 3, 4, 5, 6, 7

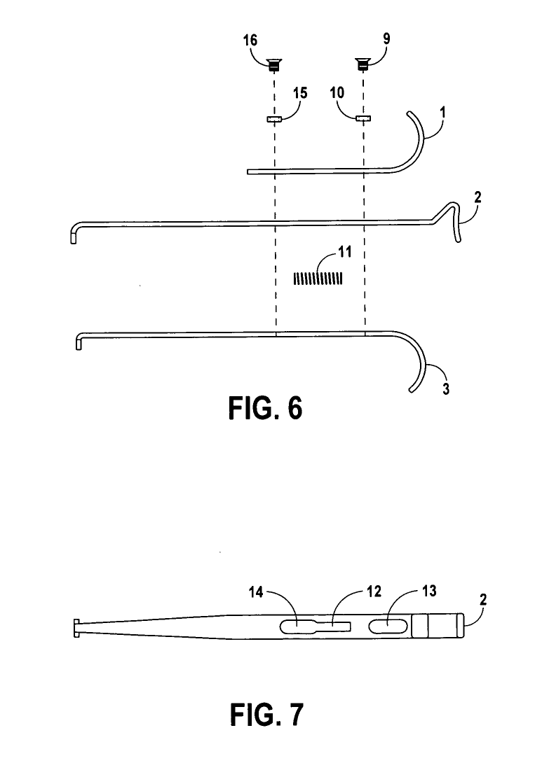

A Direct Bond Bracket Application Instrument is shown (FIG. 6), comprised of a finger support member 1, slidable member 2, and stationary member 3. A rear guide bushing 10 and forward guide bushing 15 engage a rear guide slot 13 (FIG. 7) and forward guide slot 14 to provide alignment and permit parallel linear motion. A spring 11 is nested in a spring aperture 12 and exerts a force to proximate the upper gripping jaw 4 (FIGS. 1, 3) to the lower gripping jaw 5. A rear screw 9 and a forward screw 16 join the aforementioned components into a functional assembly.

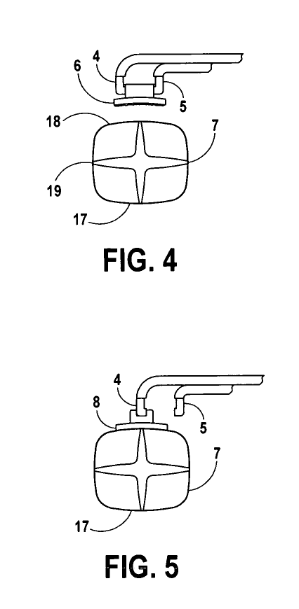

FIGS. 1 and 2 show the invention in a passive state with the gripping jaws closed by virtue of the spring force. To operate the instrument, a practitioner engages the stationary member and finger support members with the first and second fingers, and the slidable member with the opposing thumb, in a familiar hypodermic syringe style grasp. By exerting increased force upon the slidable member, the upper and lower gripping jaws will open as shown in FIG. 3. The open gripping jaws can then be placed over a bracket 6 (FIG. 4) and the force released, resulting in a secure grasp of the bracket. The practitioner would typically apply a type of cement or bonding medium to the bracket at this point, prior to affixing the bracket to the subject tooth 7. Proper view orientation of the instrument to the mouth in FIGS. 4 and 5 can be easily made by the reader by referencing Lingual 17, Buccal 18 and Distal 19 surfaces.

Occasionally after affixing a bracket, but before the bond has cured, the practitioner will desire to make an angular adjustment to the bracket position. A typical Cuspid or Bicuspid bracket 8 (FIG. 5) is provided with a vertical groove or slot which the instrument can engage to effect the adjustment. The upper and lower gripping jaws are differently sized and shaped to accommodate a range of dimensions and shapes of various bracket grooves and may be constructed with striated surfaces to aid in gripping the bracket.

If desired by the practitioner, the upper and lower gripping jaws may be fabricated of a magnetic material for the purpose of retrieval of errant or de-mounted brackets from a patient's mouth.

Conclusions, Ramifications and Scope

Accordingly, the reader will see that, according to the invention, we have provided an improved orthodontic instrument which will greatly facilitate the accurate and efficient positioning, placing and bonding of orthodontic brackets.

While the above description contains many specificities, these should not be construed as limitations on the scope of the invention, but as exemplifications of the presently preferred embodiment. Many other ramifications and variations are possible within the teachings of the invention. Thus the scope of the invention should be determined by the appended claims and their legal equivalents, and not by the examples given.

We claim:

1. An orthodontic instrument particularly for holding and positioning a direct bond bracket as it is positioned and bonded to a tooth of a patient, said instrument comprising:
a: a pair of opposed gripping jaws,
b: each of said jaws being formed with an angular disposition at the terminus of a slidable member,
c: said slidable members being coupled to permit guided linear movement,
d: a spring providing a pre-determined closing force upon said gripping jaws.

2. The device of claim 1 wherein said gripping jaws have striated surfaces.

3. The device of claim 1 wherein said gripping jaws are constructed of a suitable magnetized material.

4. The device of claim 1 wherein said gripping jaws are rotatably coupled to said slidable members for the purpose of altering their angular disposition.

5. The device of claim 1 wherein said gripping jaws are formed with a blade shape suitable for engagement with a bracket for the purpose of angular positioning.

6. An orthodontic instrument particularly for holding and positioning a direct bond bracket as it is positioned and bonded to a tooth of a patient, said instrument comprising:
a: a pair of opposed gripping jaws,
b: one of said gripping jaws being formed with an angular disposition at the terminus of a slidable member,
c: the other said gripping jaw being formed with an angular disposition at the terminus of a stationary member,
d: said stationary member at the terminus opposite to said gripping jaw being formed to comfortably engage a finger,
e: a finger support member,
f: said finger support member being formed to comfortably engage a finger,
g. said slidable member and said stationary member being coupled to permit guided linear movement,
h: said slidable member at the terminus opposite to said gripping jaw being formed to comfortably engage a thumb,
i: a spring providing a pre-determined force to cause said slidable member with said gripping jaw to proximate said stationary member with said gripping jaw and provide closing tension,
j: said spring being fully enclosed within said orthodontic instrument by means of an aperture in said slidable member and a groove in said finger support member and said stationary member.

7. The device of claim 6 wherein said gripping jaws have striated surfaces.

8. The device of claim 6 wherein said gripping jaws are constructed of a suitable magnetized material.

9. The device of claim 6 wherein said gripping jaws are rotatably coupled to said slidable members for the purpose of altering their angular disposition.

10. The device of claim 6 wherein said gripping jaws are formed with a blade shape suitable for engagement with a bracket for the purpose of angular positioning.
